(19) United States
(12) Patent Application Publication
(10) Pub. No.: US 2009/0036211 A1
(43) Pub. Date: Feb. 5, 2009

(54) GUITAR GAME APPARATUS

(75) Inventor: Laisuo Li, Shenzhen (CN)

Correspondence Address: Eric Chan, 42 Pin Oaks Drive, Phoenixville, PA, 19460, US

(73) Assignee: Topway Electrical Appliance Company, Shenzhen (CN)

(21) Appl. No.: 11/833,255

(22) Filed: Aug. 3, 2007

(51) Int. Cl. A63F 13/02

(52) U.S. Cl. 463/37; 463/35

(57) ABSTRACT

A guitar game apparatus includes a neck portion, a printed circuit board mounted to the neck portion, a first set of controlling buttons mounted to the neck portion adjacent an end, and a second set of controlling buttons mounted to the neck portion adjacent an opposite end. The printed circuit board includes a plurality of switches. A number of the first set of controlling buttons is same to that of the second set of controlling buttons. Two corresponding controlling buttons of the first and second sets of controlling buttons are electrically connected to a corresponding switch of the printed circuit board.

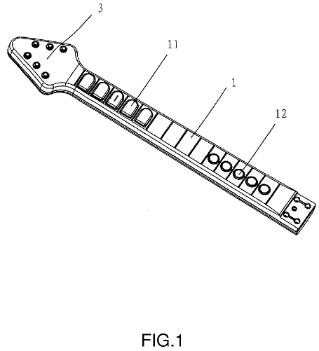

### BACKGROUND OF THE INVENTION

The present invention relates to game apparatuses, and particularly to a guitar game apparatus.

Traditionally, there are many kinds of guitar game apparatus that resemble guitars and have stored sound files that are transmitted by a microcontroller through a speaker to produce sounds that resemble those made by a guitar. The guitar game apparatuses basically work in conjugation with Sony's PS2, Microsoft's X-Box, or other game controlling apparatus. A traditional guitar game apparatus includes a head portion, a slim neck portion, and a body. Differences between the guitar game apparatus and a guitar are that the body of the guitar game apparatus needs not define sound hole and assembling strings, but sets a plurality of controlling buttons on the body. The guitar game apparatus produces sounds when the controlling buttons are pressed. However, the controlling buttons are set on the body, which is inconvenient when the players use two hands to play the guitar game apparatus.

Currently, a guitar game apparatus that overcomes the above-mentioned shortcomings is disclosed. The guitar game includes a plurality of controlling buttons set on a neck portion thereof, which is convenient for the players to play the guitar game apparatus by two hands. However, the controlling buttons are set on the neck portion and adjacent a head portion of the guitar game apparatus, which is not convenient for players who are short to operate the controlling buttons for a long time.

What is needed is to provide a guitar game apparatus which is convenient to be operated by players who have different heights.

### BRIEF SUMMARY OF THE INVENTION

An exemplary guitar game apparatus includes a neck portion, a printed circuit board mounted to the neck portion, a first set of controlling buttons mounted to the neck portion adjacent an end, and a second set of controlling buttons mounted to the neck portion adjacent an opposite end. The printed circuit board includes a plurality of switches. A number of the first set of controlling buttons is same to that of the second set of controlling buttons. Two corresponding controlling buttons of the first and second sets of controlling buttons are electrically connected to a corresponding switch of the printed circuit board.

Other objects, advantages and novel features of the invention will become more apparent from the following detailed description when taken in conjunction with the accompanying drawing, in which:

### BRIEF DESCRIPTION OF THE DRAWINGS

The drawing is an isometric view of a guitar game apparatus in accordance with an embodiment of the present invention.

### DETAILED DESCRIPTION OF THE INVENTION

Referring to the drawing, a guitar game apparatus in accordance with an embodiment of the present invention includes a body (not shown), a head portion 3, and a neck portion 1 located between the body and the head portion 3. A print circuit board (not shown) is mounted in the neck portion 1. A plurality of switches (not shown) is formed on the printed circuit board to controlling games of the guitar game apparatus.

The neck portion 1 includes two sets of controlling buttons 11, 12 mounted thereto. Each set of controlling buttons of the controlling buttons 11, 12 are linearly arranged along the neck portion 1. One set of controlling buttons 11 are located at an upper part of the neck portion 1 and adjacent the head portion. The other set of controlling buttons 12 are located at a lower part of the neck portion 1 and adjacent the body. A number of each set of controlling buttons is same. The controlling buttons of one set of controlling buttons 11 and the controlling buttons of the other set of controlling buttons 12 have a one-to-one correspondence. Two corresponding controlling buttons of the two sets of controlling buttons 11, 12 controls a corresponding switch of the printed circuit board. Thus, the switch can be controlled by synchronously operating two corresponding controlling buttons or operating one of the two corresponding controlling buttons of the two sets of controlling buttons 11, 12.

In this embodiment, the number of each set of controlling buttons is five. The five controlling buttons of each set of controlling buttons from top to bottom in turn act as the R2 button, the O button, the Δ button, the X button, and the □ button of a PS handle.

It is believed that the present invention and its advantages will be understood from the foregoing description, and it will be apparent that various changes may be made thereto without departing from the spirit and scope of the invention or sacrificing all of its material advantages, the example hereinbefore described merely being an exemplary embodiment of the invention.

We claim:

1. A guitar game apparatus, comprising:
a neck portion;
a printed circuit board mounted to the neck portion, the printed circuit board comprising a plurality of switches;
a first set of controlling buttons mounted to the neck portion adjacent an end; and
a second set of controlling buttons mounted to the neck portion adjacent an opposite end;
wherein a number of the first set of controlling buttons is same to that of the second set of controlling buttons, two corresponding controlling buttons of the first and second sets of controlling buttons are electrically connected to a corresponding switch of the printed circuit board.

2. The guitar game apparatus as claimed in claim 1, wherein a number of each set of the first and second sets of controlling buttons is five.

3. The guitar game apparatus as claimed in claim 2, wherein the five controlling buttons of each set of the first and second sets of controlling buttons act as the R2 button, the O button, the Δ button, the X button, and the □ button of a PS handle.

4. The guitar game apparatus as claimed in claim 1, wherein the controlling buttons of each of the first and second sets of controlling buttons are linearly arranged along the neck portion.

5. The guitar game apparatus as claimed in claim 1, further comprising a head portion and a body, wherein the neck portion is located between the head portion and the body, the first set of controlling buttons is adjacent the head portion, and the second set of controlling buttons is adjacent the body.
